(19) United States
(12) Patent Application Publication
(10) Pub. No.: US 2022/0311637 A1
(43) Pub. Date: Sep. 29, 2022

(54) IMMERSION-COOLED BATTERY WITH WIRELESS COMMUNICATION SYSTEM

(71) Applicant: ST@RTEC DEVELOPPEMENT, Merignac (FR)

(72) Inventors: BENJAMIN LOGIE, BORDEAUX (FR); THOMAS DEBUISSER, SALLEBOEUF (FR); XAVIER PETITDIDIER, LACANAU (FR)

(21) Appl. No.: 17/705,203

(22) Filed: Mar. 25, 2022

(30) Foreign Application Priority Data
Mar. 25, 2021 (FR) 2103015

(51) Int. Cl. H04L 12/40; H04L 5/14; G08C 17/02; G08C 23/00

(52) U.S. Cl. CPC H04L 12/40; H04L 5/14; G08C 17/02; G08C 23/00; H04L 2012/40215; B60R 16/02

(57) ABSTRACT

An immersion-cooled battery including at least one module provided with a wireless communication system as an interface between a battery management system (BMS) and a data bus outside the module to ensure the tightness of the module. The module includes an enclosure filled with a cooling fluid into which electrochemical cells and the BMS are immersed. The wireless communication system, connected to the BMS, includes radiofrequency or optical wave emission and reception components, an inner unit and an outer unit, respectively located inside and outside the enclosure. The inner and outer units communicating through all-or-nothing raw signals propagating through at least one porthole embedded in a wall of the enclosure.

### TECHNICAL FIELD

The present invention relates to the field of immersion-cooled batteries for electric vehicles or stationary applications. More particularly, the invention covers a battery with immersed electric cells including a wireless communication system.

### BACKGROUND OF THE INVENTION

The technical management of electric batteries is a major concern for electric vehicle manufacturers. Lithium-ion batteries or the same have heat-up or short-circuits problems that might reduce the service life of the battery or generate fires.

Immersion cooling is an excellent solution to avoid short-circuits, heat-up and damage of the battery. This technique consists in immersing the electrochemical cells of modules of the battery into a fluid to enable a quick evacuation of calories. More particularly, the electrochemical cells and generally the battery management system “BMS” are placed inside an enclosure filled with a fluid such as oil or a coolant. Depending on the cooling need, the enclosure may be filled with a fluid in a liquid phase, in a gaseous phase, or in two-phase.

Immersion cooling is an advantageous solution with regards to thermal management and the application requiring very high powers, nonetheless, it brings in new constraints to the management of the modules of the battery. Indeed, the battery of the electric vehicle is formed by several modules connected and communicating together in order to manage at best the performance of the battery and the safety of use thereof. This communication of the modules typically implements a wired link, which poses tightness problems in an immersion-cooled battery. For example, in the architecture of existing electric batteries, the external data bus is typically connected in a wired manner with the BMS throughout non-hermetic connectors located at the enclosure of the modules. Hence, the fluid inside the enclosure could leaks through these connectors.

A solution to this problem consists in connecting the BMS to the data bus throughout a cable crossing the wall of the enclosure of the module via an outlet including a cable grommet, this cable grommet clamping the cable very strongly to enable a relatively tight closure at the outlet of the enclosure. Nevertheless, this solution is not enough to guarantee tightness of the modules because of the gas or liquid that might intrude into the cable at each of its ends where the inner wires are stripped.

Hence, it is desirable to establish a wireless communication between the BMS and the wired standard data bus outside the battery. Nonetheless, there are several technical constraints for the transmission of these signals, first of all from a physical perspective and the high degree of interfering materials that might affect the quality of the transmission.

Besides, the communication protocols of a data bus embeds several analog level rules and control rules to be met, and that being so starting from their low hardware layer.

For example, consider the CAN (Controller Area Network) communication bus and the shaping of the signal for embedment thereof in the data bus. The commonly-used microcontrollers are not directly compatible. The microcontrollers have an emission signal TX and a reception signal RX. These signals are nevertheless made specific to the Can by the low physical and software layers of the microcontroller and then become CAN_TX and CAN_RX signals. Afterwards, it is necessary to use a specific component, a CAN driver, to transform these CAN_TX and CAN_RX into differential signals CAN HIGH and CAN LOW, the signals of the CAN bus. Nonetheless, this communication protocol is difficult to replicate with a wireless communication module.

### OBJECT AND SUMMARY OF THE INVENTION

The invention aims to provide a communication system for an immersion-cooled battery that does not affect the tightness of said battery.

Another objective of the invention is that this system is adapted for integration thereof in the computer architecture of an electric vehicle, and in particular that it can be connected to a wired data bus.

To this end, the invention provides an immersion-cooled battery, including at least one module including an enclosure filled with a cooling fluid into which electrochemical cells and a battery management system “BMS” are immersed, characterised in that:
said battery includes a wireless communication system connected to said battery management system BMS, and includes radiofrequency or optical wave emission and reception components, and in that
the wireless communication system includes an inner unit and an outer unit respectively located inside and outside said enclosure, said inner and outer units communicating through all-or-nothing raw signals propagating through at least one porthole embedded in a wall of the enclosure, and in that
said porthole is permeable to at least part of the visible spectrum, infrared spectrum and/or very-high frequency band waves.

Thus, the invention provides an effective solution for setting the BMS in communication with a data bus, without affecting the tightness of the module and ensuring the propagation of signals in an environment that might affect a wireless transmission.

Preferably, the outer unit includes an electronic board and wired link connectors Tx, Rx connected to a data bus implementing a communication protocol selected from among CAN, SPI, ISOSpi, Ethernet or RS232/485, and the signals exchanged between the inner unit and the outer unit embed a physical (also called “couche matérielle” in french) layer or a lowest physical sublayer of the protocol of the data bus. For example, the communication system is configured to be embedded in a CAN bus, and the signals exchanged between the inner unit and the outer unit embeds only a communication protocol with the lowest physical sublayer of the CAN bus, i.e. the PLS “Physical Signalling” sublayer. Thus, it is possible to ensure continuity in the transmission of signals originating from or in the direction of the data bus, with the signals exchanged between the inner and outer unit of the wireless communication system.

Hence, the inner and outer units are configured so as not modify a communication protocol of the low material or physical layer of the signals to be transmitted.

In one embodiment, the management system of the immersed battery is a slave BMS and the signals to be exchanged between the inner unit and the outer unit include:
a so-called “on/off” life frame to awaken and/or set in standby an electronic board of said BMS;
raw data frames including voltage and temperature measurements of the electrochemical cells of said module, and/or
a good health bit.

In another embodiment, the management system of the battery is a master BMS and the signals to be exchanged between the inner unit and the outer unit include:
a so-called “on/off” life frame to awaken and/or set in standby an electronic board of said BMS; and
structured data frames including one or several data selected from among a state-of-health, a state-of-charge, operation data or statistics and/or tome interpretations of said module, and optionally
raw data frames including voltage and temperature measurements of the electrochemical cells of said module and/or a good health bit.

According to an embodiment of the invention, the inner unit and the outer unit communicate throughout full-duplex or half-duplex optical signals, by means of a plurality of optical emission and reception components dedicated, respectively, to the communication of the predefined content signals.

For example:
a first signal including the “on/off” life frame is transmitted by means of a first optical emitter from the outer unit to a first optical receiver of the inner unit;
a second signal including data frames is transmitted and received by means of a second optical emitter and a second optical receiver, i.e. an emitter-receiver pair in each of the inner and outer units to communicate in full-duplex;
a third signal including the good health bit is transmitted by means of a third optical emitter from the inner unit to a third optical receiver of the outer unit.

In particular, the emission components of the invention are optical emitters formed by an infrared emitter diode and a laser diode essentially accompanied with a drive circuit, and the reception components are optical receptors formed by a receiver diode, essentially followed by an amplifying and filtering circuit.

According to one embodiment, the enclosure includes one single porthole and each signal to be transmitted is propagated throughout said porthole via a channel with different wavelength and predefined for each signal to be transmitted. Namely, the enclosure includes a plurality of portholes for each signal to be transmitted, and said transmission is performed by a channel with one single wavelength for the emission of a set of signals and/or for reception thereof.

According to another embodiment, the inner unit and the outer unit respectively include an antenna associated to an ultra-high frequency emitter/receiver such as Wi-Fi or GSM, and exchanged frames comprise all or part of the signals to be exchanged.

The battery of the invention may also include a plurality of modules respectively provided with a wireless communication system.

The invention also relates to a vehicle embedding a battery according to the invention, such as a car, a train, an aircraft, a bus or a commercial vehicle.

### BRIEF DESCRIPTION OF THE DRAWINGS

The invention will be better understood from the description, made hereinafter for merely explanative purposes, of the embodiments of the invention with reference to the figures:

FIG. 1: A schematic representation of the battery of the invention including a wireless communication system according to a first embodiment.

FIG. 2: A schematic representation of the battery of the invention including a wireless communication system according to a second embodiment.

FIG. 3: A schematic representation of the battery of the invention including a plurality of modules and its link to a data bus.

FIG. 4A schematic representation of the signal transmission according to the invention for a CAN bus.

### DETAILED DESCRIPTION OF THE EMBODIMENTS OF THE INVENTION

The present invention relates to an immersion-cooled battery including at least one module provided with a wireless communication system.

More particularly, the invention relates to a battery bank requiring a perfect electrical and thermal management including a plurality of modules, each module being provided with a wireless communication module as an interface between a battery management system “BMS” and a data bus connecting the modules to a central processor.

The battery of the invention is especially designed to be embedded in an electric vehicle and in a modular system for managing the battery of the vehicle. For example, the battery is a battery of an electric vehicle, a bus, a train, or a commercial vehicle requiring high power, or a stationary electric battery.

FIGS. 1 to 3 illustrate a schematic representation of an immersion-cooled battery module 10 according to different embodiments of the invention. Irrespective of the embodiment, the module 10 includes an enclosure 1 accommodating therein electrochemical cells 8 connected in series or in parallel, and a battery management system “BMS” 2. An internal volume of the enclosure 10 is filled with a fluid 9 into which the cells 8 and the BMS 2 are immersed, this fluid may be in a liquid, gaseous phase or a combination thereof. The electrochemical cells may be of the lithium-ion or sodium-ion type, nonetheless, the invention is not limited to a specific type of electrochemical cells.

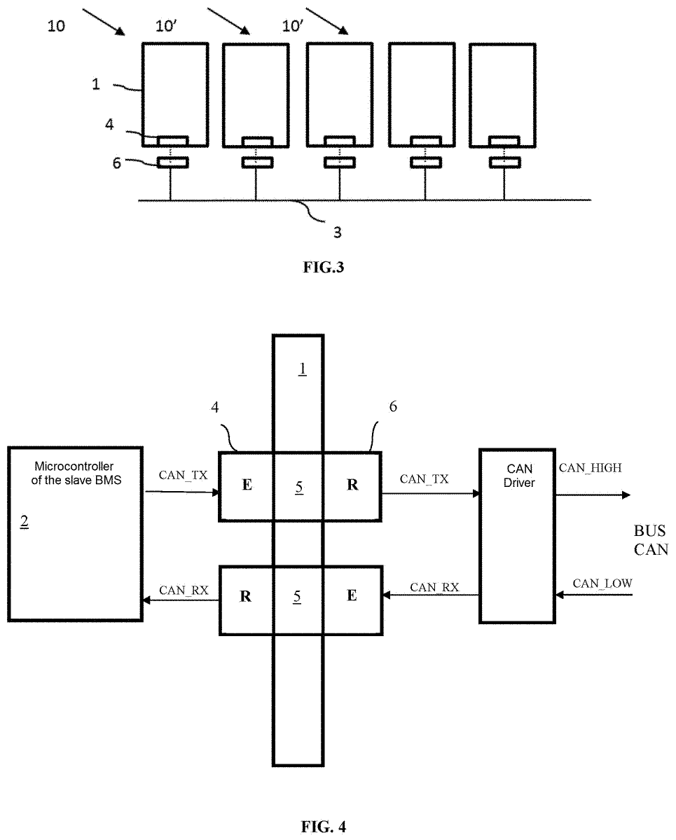

Advantageously, the invention suggests providing each module of the battery with a wireless communication system allowing connecting the BMS 2 with the data bus outside the enclosure without affecting the tightness of the module. The wireless communication system includes an inner unit 4 connected in a wired manner to the BMS and an outer unit 6 connected to the data bus, each inner and outer unit respectively including, an electronic board, wired connectors Tx, Rx, radiofrequency or optical wave emission and reception components, these being adapted to transmit a signal compatible with a basic communication protocol of the data bus (CAN, SPI, ISOSpi, RS232/485, Ethernet . . . ). More particularly, the invention suggests transmitting on-off control raw signals, known in French as “TOR” signals (which stands for “Tout ou Rien” in French), and embedding only the communication protocol of the lowest and rawest layer, or sublayer of the communication bus. For example, for a CAN bus (FIG. 4), the lowest layer of the protocol is the “physical layer” and the lowest sublayer of the physical layer is the PLS “Physical signalling” sublayer, the latter being in charge of encoding and decoding bit, of timing bit and of synchronisation. The raw signals “TOR” TX and RX of the lowest sublayer have not been modified by a driver or a transceiver for example to apply the second sublayer PMA “Physical Medium Attachment” of the CAN, the latter allowing transmitting differential signals CAN HIGH and CAN LOW.

Regardless of the embodiment and of the communication protocol of the data bus, the signals are transmitted in a raw state, and before the encapsulation of data by the link layer of the data bus. Thus, raw signals of on-off control type, it should be understood in the present invention, that the signal is in a raw, non-differential binary state before data encapsulation.

Thus, the outer unit 6 may be connected in a wired manner to the data bus for the data transmission to the application of the vehicle in a conventional manner. Of course, before embedment thereof to the data bus, these signals will be processed to apply the other layers of the communication protocol. As illustrated in FIG. 4, in the case of the CAN protocol, the signals will be embedded to the bus as CAN HIGH and CAN LOW by applying the sublayer PMA by a driver or transceiver in a known manner.

In order to optimise the communication between the inner unit 4 and the outer unit 6, the invention suggests embedding at least one porthole 5 permeable to electromagnetic waves on a wall of the enclosure 1, i.e. an aperture or a conduit tightly installed, crossing the wall of the enclosure, and being permeable to a range of predefined wavelengths and frequencies, such as at least one portion of the visible and infrared spectrum band (for the optical transmission) or of the very-high frequency band (for the radiofrequency wave transmission).

The inner unit 4 is disposed at the porthole 5, or at least substantially close thereto to increase the effectiveness of signal transmission out of the enclosure 1. The external unit 6 is also located in a proximate area of said porthole. Thus, the inner 4 and outer 6 units could communicate together without any possible disturbance imparted by the material of the enclosure. Similarly, the inner and outer units are close enough to guarantee a communication that is stable, quick and without any disturbance from the other electronic components and materials of the car.

In an embodiment of the invention, the outer unit 6 is configured to transmit a so-called “on/off” life frame to the inner module 4 and awaken an electronic board of the BMS. In reply, the BMS communicates one or several signal(s) including data on the operating state of the module.

The wireless communication system of the invention may be implemented with a slave or master type immersed BMS 2. A master BMS includes an immersed smart board embedding signal processing functions, while a slave BMS transmits signals out of the module for processing thereof by a master BMS outside the module.

More particularly, the slave BMS is configured to transmit raw data on the measured voltages and temperatures to a master BMS located outside the module. Hence, the slave BMS includes an electronic board connected to a plurality of measuring boards, such ASICs specialised in battery management and which could drive the balance (such as MAX11068, LTC6811, DS2726, AD7280, ISL9216), as well as other components for ensuring the operation of said BMS such as: switching regulators for generating the power supplies needed for the operation of the other components of the board (i.e. AP1117, TDA3663), signal control transistors (i.e. BSS84, 2N7002), passive components such as resistors, capacitors, coils or diodes, harness connectors and possibly (wired or wireless) communication drivers, such as TCAN1146, SN65HVD, LTC2875 or MAX3057 for CAN for example.

In another embodiment, the immersed BMS 2 is a master or smart BMS, measuring the temperature and the voltage of the cells, but also embedding data processing means for supplying structured data to an external application, such as a state-of-health, a state-of-charge, and different quantified data (particular event counters, time interpretations, etc.). Hence, the master BMS 2 includes a smart electronic board and embedding the measuring boards and the components selected for the slave BMS, as well as a microcontroller (i.e. for example an 8 to 32 bit microcontroller from the R8C family), optocouplers, operational amplifiers, logic gates, power components, etc.

For example, the state-of-health or “SOH” quantifies the ageing degree of the cells of the module based on its inner impedance loss and/or capacity loss, it is therefore essential to assess the state of availability of the backup power supply equipment and forms an indicator of the need for maintenance actions on the battery. In one embodiment, the electronic board of the inner unit 4 receives from the master BMS via a wired link a state-of-health signal from the module 10 which transmits it to the outer unit 6, said state-of-health being computed by the master BMS in the form of a capacity percentage remaining in the electrochemical cells of the module (i.e. 80% of capacity).

Whether it is slave or master, the BMS 2 is also configured to transmit a signal including a good health bit, for example in the form of a signal periodically switching from 0 to 1 and vice versa. The good health bit allows signalling a good operation state of the electronic board of the BMS, and in particular that the measuring boards and/or the microcontroller are operational.

According to an embodiment of the invention, the wireless communication system implements a radiofrequency wave transmission process (i.e., Wi-Fi, GSM . . . ) or an optical communication process (i.e., infrared, laser).

FIG. 1 illustrates a first embodiment of the radiofrequency wave wireless communication system. An advantage of this embodiment is a relatively free setup of the inner 4 and outer+units of the wireless communication system. The inner unit 4 is positioned inside the enclosure close to the porthole, and preferably facing the porthole 5 to optimise data transmission out of the module 10. The outer unit 6 may be placed at will depending on the data integration level desired for the data bus. For example, it could be located closer to a node of the data bus dedicated to said module 10.

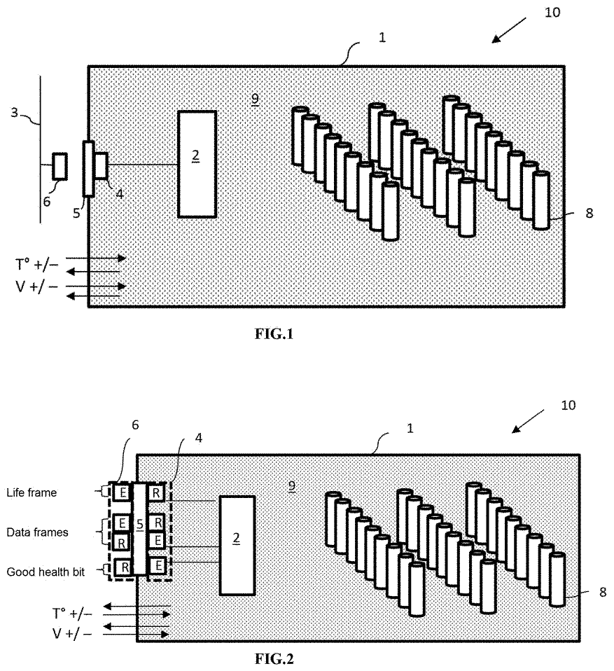

FIG. 2 illustrates a second embodiment of the wireless communication system with optical communication. In this embodiment, the inner 4 and outer units are preferably located opposite one another, on either side of the porthole 5. In particular, the invention suggests assigning dedicated channel and emission and reception components to each signal to be transmitted (i.e., data frames, good health bit, on/off life frame). For example, the invention suggests implementing a specific wavelength for the signal including the on/off life frame, another wavelength for the signal including data frames, and another wavelength for the good health bit. Thus, it is possible to transmit all signals throughout one single porthole and limit the adaptation costs of the enclosure, while limiting interferences between the signals propagating through this single porthole.

As illustrated in FIG. 2, in this embodiment, the inner unit and the outer unit include a plurality of optical emitters E and of optical receivers R dedicated to each signal to be transmitted. In particular an optical emitter-receiver pair in each of the inner 4 and outer 6 units for transmitting data frames in a bidirectional way, and an emitter E in the outer unit dedicated to transmit the life frame through a one-directional channel to a receiver R of the outer unit 6. In another embodiment, the module includes a plurality of independent inner units and outer units and embedding said plurality of optical emitters E and receivers.

Advantageously, in this embodiment implementing an optical transmission process, the porthole is implemented in the form of an aperture and preferably includes a material allowing filtering at least partially the visible spectrum light in order to optimise the optical transmission of data, and limit parasites such as daylight, or of a neon light. In another embodiment, the porthole may be implemented as a conduit enabling the passage of an optical signal, tightly crossing the wall and substantially extending on either side of the wall of the enclosure. Of course, the openings of this conduit are tight at its ends.

In a third embodiment, the communication is done via one single channel and the module 10 includes a porthole and emission and/or reception components for each signal to be transmitted and including a predefined content. For example, a first porthole for the transmission of a signal including the on/off life frame a second porthole for the signal including the data frames, and a third porthole for the signal including the state-of-health or a good health bit.

In a preferred embodiment, the emission components are optical emitters formed by an infrared emitter diode such as HSDL-4220 essentially accompanied with a drive circuit, and possibly with a MOS set to adapt the power supply voltage where needed and impose a rest state. The reception components are optical receptors formed by a receiver diode such as BPV22NF, essentially followed by an amplifying and filtering circuit, such as LT328CS8. Indeed, it is desired to provide the most basic components as possible and so as to transmit a raw signal, without any modulation or transformation of the signal, as well as other functions specific to conventional infrared communication protocols such as the RCS protocol.

Thus, the invention offers an effective communication system for an immersion-cooled battery, said system being adapted to work with high-rate data transmissions (1 Mb/s) but also with stable states, for example by means of the TOR inputs/outputs. The data transmission is ensured without affecting the tightness of the modules, and the battery would be easily embedded in an electric vehicle without questioning the design of its computer network.

1-14. (canceled)

15. An immersion-cooled battery comprising:
at least one module comprising an enclosure filled with a cooling fluid into which electrochemical cells and a battery management system (BMS) are immersed,
a wireless communication system, connected to the BMS, comprises radiofrequency or optical wave emission and reception components, an inner unit and an outer unit respectively located inside and outside the enclosure, the inner unit and the outer unit communicating through raw signals of on-off control type propagating through at least one porthole embedded in a wall of the enclosure, said at least one porthole is permeable to at least one portion of at least one of the following: a visible spectrum, infrared spectrum and frequency band waves.

16. The battery of claim 15, wherein the outer unit comprises an electronic board and wired link connectors to connect to a data bus and to transmit and receive the raw signals, and wherein the raw signals exchanged between the inner unit and the outer unit embeds only a communication protocol of a lowest physical layer or lowest physical sublayer of the data bus.

17. The battery of claim 15, wherein the wireless communication system is configured to be embedded in a controller area network bus, and the raw signals exchanged between the inner unit and the outer unit embeds only a communication protocol of a lowest physical sublayer of the controller are network bus.

18. The battery of claim 15, wherein the battery management system of the battery is a slave BMS and the raw signals to be exchanged between the inner unit and the outer unit comprise:
an on/off life frame to awaken or set in standby the electronic board of the BMS;
raw data frames comprising voltage and temperature measurements of the electrochemical cells of said at least one module; and
a good health bit.

19. The battery of claim 15, wherein the management system of the battery is a master BMS and the signals to be exchanged between the inner unit and the outer unit comprise:
an on/off life frame to awaken or set in standby an electronic board of the BMS; and
structured data frames comprising one or more data selected from among a state-of-health, a state-of-charge, operation data or statistics and/or tome interpretations of said module; and
optionally raw data frames comprising voltage and temperature measurements of the electrochemical cells of said the or a good health bit.

20. The battery of claim 15, wherein the inner unit and the outer unit communicate throughout full-duplex or half-duplex optical signals, and the wireless communication system comprises a plurality of optical emission and reception components dedicated, respectively, to communication of predefined content signals.

21. The battery of claim 15, wherein the emission components are optical emitters formed by an infrared emitter diode and a laser diode essentially accompanied with a drive circuit; and the reception components are optical receptors formed by a receiver diode, essentially followed by an amplifying and filtering circuit.

22. The battery of claim 20, wherein:
a first signal comprising an on/off life frame is transmitted by a first optical emitter from the outer unit to a first optical receiver of the inner unit;
a second signal comprising raw data or structured data frames is transmitted and received by a second optical emitter and a second optical receiver in each of the inner and outer units; and
a third signal comprising a good health bit is transmitted by a third optical emitter from the inner unit to a third optical receiver of the outer unit.

23. The battery of claim 20, wherein the enclosure comprises one single porthole and each signal to be transmitted is propagated throughout said one single porthole via a channel with a different wavelength and predefined for said each signal to be transmitted.

24. The battery of claim 20, wherein the enclosure comprises a plurality of portholes for each signal to be transmitted via a channel with one single wavelength for an emission of a set of signals.

25. The battery of claim 20, wherein said at least one porthole is implemented in a form of a conduit tightly crossing the wall of the enclosure and enabling the transmission of said optical signals.

26. The battery of claim 15, wherein the inner unit and the outer unit respectively comprise an antenna associated to an ultra-high frequency emitter/receiver; and
exchanged frames comprise all or part of the raw signals to be exchanged.

27. The battery of claim 26, wherein the antenna is a Wi-Fi or GSM antenna.

28. The battery of claim 15, further comprising a plurality of modules respectively provided with a wireless communication system.

29. A vehicle embedding a battery of claim 15.

30. The vehicle of claim 29 is a car, a train, an aircraft, a bus or a commercial vehicle.
